(19) United States
(12) Patent Application Publication
(10) Pub. No.: US 2009/0255911 A1
(43) Pub. Date: Oct. 15, 2009

(54) LASER SCRIBING PLATFORM AND HYBRID WRITING STRATEGY

(75) Inventors: Sriram Krishnaswami, Saratoga, CA (US); Shinichi Kurita, San Jose, CA (US); Bassam Shamoun, Fremont, CA (US); Benjamin M. Johnston, Los Gatos, CA (US); John M. White, Hayward, CA (US); Jiafa Fan, San Jose, CA (US); Inchen Huang, Fremont, CA (US); Antoine P. Manens, Sunnyvale, CA (US); Wei-Sheng Lei, San Jose, CA (US); Wei-Yung Hsu, Santa Clara, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/422,189

(22) Filed: Apr. 10, 2009

Related U.S. Application Data
(60) Provisional application No. 61/044,021, filed on Apr. 10, 2008.
(60) Provisional application No. 61/044,027, filed on Apr. 10, 2008.

(51) Int. Cl. B23K 26/38; B23K 26/02; B23K 26/067; B23K 26/08

(52) U.S. Cl. 219/121.69; 219/121.68; 219/121.76; 219/121.82; 219/121.83

(57) ABSTRACT

Laser scribing can be performed on a workpiece (104) such as substrates with layers formed thereon for use in a solar panel without need to rotate the workpiece (104) during the scribing process. A series of lasers (602, 622) can be used to concurrently remove material from multiple positions on the workpiece (104). Each laser (602, 622) can have at least one scanning device (614, 630, 632) positioned along a beam path thereof in order to adjust a position of the laser output relative to the workpiece (104). By adjusting the beam or pulse positions using the scanning devices (614, 630, 632) while translating the workpiece (104), substantially any pattern can be scribed into at least one layer of the workpiece (104) without the need for any rotation of the workpiece (104).

### CROSS-REFERENCES TO RELATED APPLICATIONS

This application claims the benefit of U.S. Provisional Application Nos. 61/044,021, filed Apr. 10, 2008; and 61/044,027, filed Apr. 10, 2008; which are hereby incorporated herein by reference.

### BACKGROUND

Various embodiments described herein relate generally to the scribing of materials, as well as systems and methods for scribing the materials. These systems and methods can be particularly effective in scribing single-junction solar cells and thin-film multi-junction solar cells.

Current methods for forming thin-film solar cells involve depositing or otherwise forming a plurality of layers on a substrate, such as a glass, metal or polymer substrate suitable to form one or more p-n junctions. An example of a solar cell has an oxide layer (e.g., a transparent-conductive-oxide (TCO) layer) deposited on a substrate, followed by an amorphous-silicon layer and a metal back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a panel is being formed from a large substrate, a series of scribe lines is typically used within each layer to delineate the individual cells. In previous approaches, this involved moving a substrate relative to at least one laser, in order to generate the scribe lines. If the solar cells included scribe lines in multiple directions on the panel, such as both longitudinal and latitudinal scribe lines, then it was necessary to rotate the substrate with respect to the lasers. Further, these devices did not allow for variations in the scribe lines where patterns other than straight lines are desired. Even further still, there was no way to perform minor adjustments to minimize deviations from the intended scribe-line positions.

Accordingly, it is desirable to develop systems and methods that overcome at least some of these, as well as potentially other, deficiencies in existing scribing and solar panel manufacturing devices.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems and methods for scribing a workpiece are provided. Various embodiments can provide for improved control, as well as the ability to scribe in multiple directions and/or patterns without rotating the substrate. System and methods in accordance with various embodiments provide for general purpose, high-throughput, direct patterning laser scribing on large film-deposited substrates. These systems and methods can be particularly effective in scribing single-junction solar cells and thin-film multi-junction solar cells.

In many embodiments, a system for scribing a workpiece is provided. The system includes a translation stage operable to support the workpiece and translate the supported workpiece in a longitudinal direction, a laser operable to generate output able to remove material from at least a portion of the workpiece, a scanning device operable to control a position of the output from the laser, and a controller. The controller is coupled with the translation stage, the laser, and the scanning device. The controller is operable to coordinate a position of the translation stage with the generation of an output from the laser and with a scanned position of the output from the laser. The system provides for the scribing of patterns in two dimensions on the workpiece without rotating the workpiece.

In many embodiments, a system for scribing a workpiece is provided. The system includes a translation stage operable to support the workpiece and translate the supported workpiece in a longitudinal direction, a laser operable to generate output able to remove material from at least a portion of the workpiece, and a scanning device operable to control a position of the output from the laser. The scanning device utilizes at least one scribe pattern enabling the scanning device to scribe a desired pattern into the workpiece during relative lateral motion between the scanning device and the workpiece.

In many embodiments, a method of scribing a workpiece having a longitudinal direction and a lateral direction is provided. The method includes forming a first scribe line having a direction with a lateral component by using a scanning device to direct a first series of sequential laser pulses at the workpiece, and forming a second scribe line having a direction with a lateral component by using the scanning device to direct a second series of sequential pulses at the workpiece. The second scribe line is offset from the first scribe line. The offset includes a longitudinal component.

For a fuller understanding of the nature and advantages of the present invention, reference should be made to the ensuing detailed description and accompanying drawings. Other aspects, objects and advantages of the invention will be apparent from the drawings and the detailed description that follows.

### BRIEF DESCRIPTION OF THE DRAWINGS

Various embodiments in accordance with the present invention will be described with reference to the drawings, in which:

FIG. 1 illustrates a perspective view of a laser-scribing device that can be used in accordance with many embodiments;

FIG. 2 illustrates a side view of a laser-scribing device that can be used in accordance with many embodiments;

FIG. 3 illustrates an end view of a laser-scribing device that can be used in accordance with many embodiments;

FIG. 4 illustrates a top view of a laser-scribing device that can be used in accordance with many embodiments;

FIG. 5 illustrates a set of laser assemblies that can be used in accordance with many embodiments;

FIG. 6A illustrates components of a laser assembly that can be used in accordance with many embodiments;

FIGS. 6B and 6C illustrate components of a laser-optics module that can be used in accordance with many embodiments;

FIG. 7 illustrates the generation of multiple scan areas that can be used in accordance with many embodiments;

FIG. 8 illustrates an imaging device relative to a scan area in a laser-scribing device that can be used in accordance with many embodiments;

FIG. 9 illustrates a cross section of a solar-panel assembly that can be formed using devices in accordance with many embodiments;

FIGS. 10A and 10B illustrate a longitudinal and a latitudinal scan technique, respectively, that can be used in accordance with many embodiments;

FIG. 11 illustrates a control diagram for a laser-scribing device that can be used in accordance with many embodiments;

FIG. 12 illustrates a data-flow diagram for a laser-scribing device that can be used in accordance with many embodiments;

FIGS. 13A-13C illustrate approaches for scribing lateral lines on a workpiece that can be used in accordance with many embodiments;

FIGS. 14A-14D illustrate scan patterns for scribing lateral lines on a workpiece using a serpentine approach that can be used in accordance with many embodiments;

FIGS. 15A-15D illustrate scan patterns for scribing lateral lines on a workpiece using a raster approach that can be used in accordance with many embodiments;

FIGS. 16A-16C illustrate approaches for scribing lateral lines on a workpiece that can be used in accordance with many embodiments;

FIGS. 17A-17C illustrate approaches for scribing lateral trim lines on a workpiece that can be used in accordance with many embodiments;

FIGS. 18A-18D illustrate scan patterns for scribing lateral trim lines on a workpiece that can be used in accordance with many embodiments;

FIGS. 19A and 19B illustrate an approach for scribing lateral trim lines on a workpiece that can be used in accordance with many embodiments; and

FIGS. 20A and 20B illustrate an approach for scribing longitudinal lines on a workpiece that can be used in accordance with many embodiments.

### DETAILED DESCRIPTION

Systems and methods in accordance with various embodiments of the present disclosure can overcome one or more of the aforementioned and other deficiencies in existing scribing approaches. Various embodiments can provide for improved control, as well as the ability to scribe in multiple directions and/or patterns without rotating the substrate. Devices in accordance with various embodiments provide for general purpose, high-throughput, direct-patterning laser scribing on large film-deposited substrates. Such devices allow for bi-directional scribing, patterned scribing, arbitrary pattern scribing, and/or adjustable pitch scribing, without changing an orientation of the workpiece.

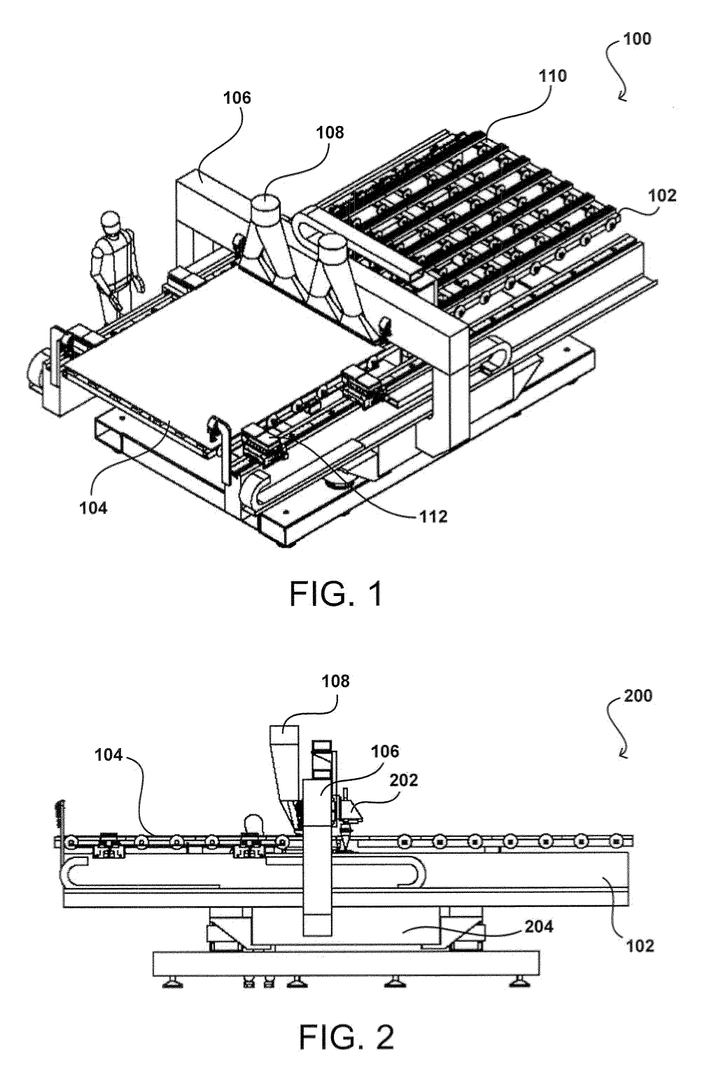

FIG. 1 illustrates an example of a laser-scribing device 100 that can be used in accordance with many embodiments. The device includes a bed or stage 102, which will typically be level, for receiving and maneuvering a workpiece 104, such as a substrate having at least one layer deposited thereon. In one example, a workpiece is able to move along a single directional vector (i.e., for a Y-stage) at a rate of up to and/or greater than 2 m/s. Typically, the workpiece will be aligned to a fixed orientation with the long axis of the workpiece substantially parallel to the motion of the workpiece in the device. The alignment can be aided by the use of cameras or imaging devices that acquire marks on the workpiece. In this example, the lasers (shown in subsequent figures) are positioned beneath the workpiece and opposite a bridge 106 holding part of an exhaust mechanism 108 for extracting material ablated or otherwise removed from the substrate during the scribing process. The workpiece 104 typically is loaded onto a first end of the stage 102 with the substrate side down (towards the lasers) and the layered side up (towards the exhaust). The workpiece is received onto an array of rollers 110 and/or air bearings, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly. The device can include at least one controllable drive mechanism 112 for controlling a direction and translation velocity of the workpiece 104 on the stage 102.

This movement is also illustrated in the side view 200 of FIG. 2, where the substrate moves back and forth along a vector that lies in the plane of the figure. Reference numbers are carried over between figures for somewhat similar elements for purposes of simplicity and explanation, but it should be understood that this should not be interpreted as a limitation on the various embodiments. As the workpiece 104 is translated back and forth on the stage 102, a scribing area of the laser assembly effectively scribes from near an edge region of the workpiece to near an opposite edge region of the workpiece. In order to ensure that the scribe lines are being formed properly, an imaging device can image at least one of the lines after scribing. Further, a beam-profiling device 202 can be used to calibrate the beams between processing of workpieces or at other appropriate times. In many embodiments where scanners are used, for example, which may drift over time, a beam profiler allows for the calibrating of the beam and/or adjustment of beam position. The stage 102, bridge 106, and a base portion 204 can be made out of at least one appropriate material, such as a base portion of granite.

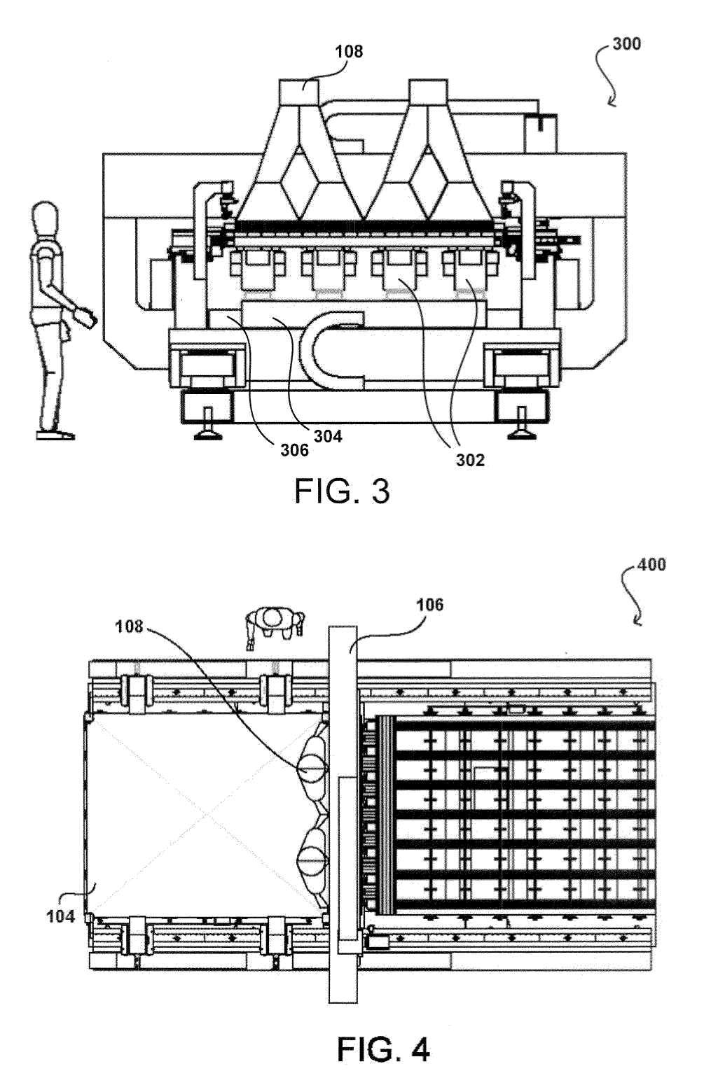

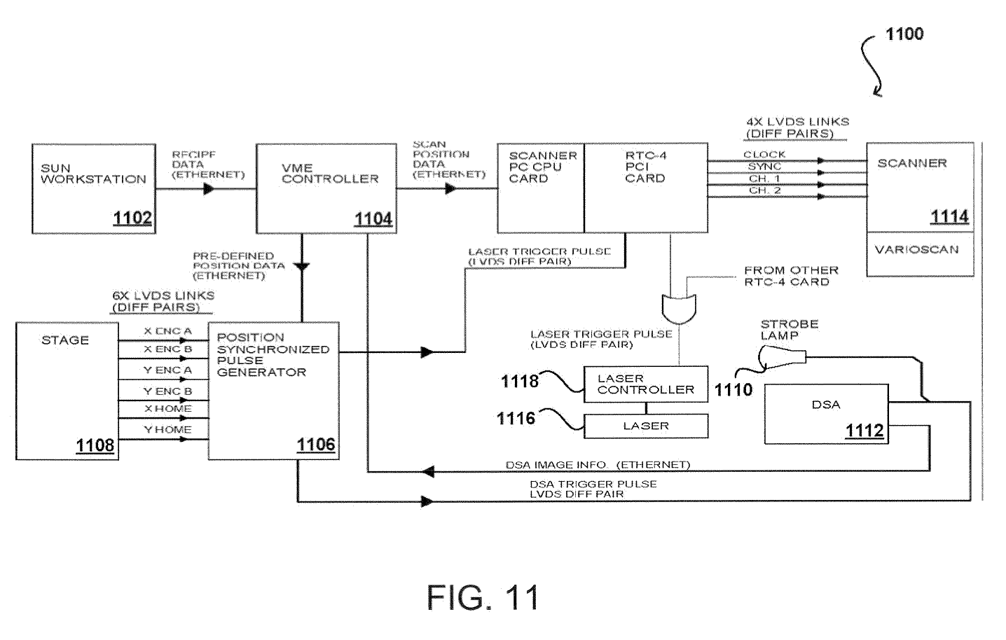

FIG. 3 illustrates an end view 300 of the example device, illustrating a series of laser assemblies 302 used to scribe the layers of the workpiece. In this example, there are four laser assemblies 302, each including a laser device and elements, such as lenses and other optical elements, needed to focus or otherwise adjust aspects of the laser. The laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. FIG. 4 is a top view 400 illustrating another view of the example device. In many embodiments, the system is a split-axis system, where the stage translates the workpiece 104 along a longitudinal axis (e.g., right to left in FIG. 4). The lasers then can be attached to a translation mechanism able to laterally translate the lasers 302 relative to the substrate (e.g., right to left in FIG. 3). For example, the lasers can be mounted on a support 304 that is able to translate on a lateral rail 306 as driven by a controller and servo motor, for example, such as is discussed with respect to FIG. 11. In many embodiments, the lasers and laser optics all move together laterally on the support 304. As discussed below, this allows shifting scan areas laterally and provides other advantages.

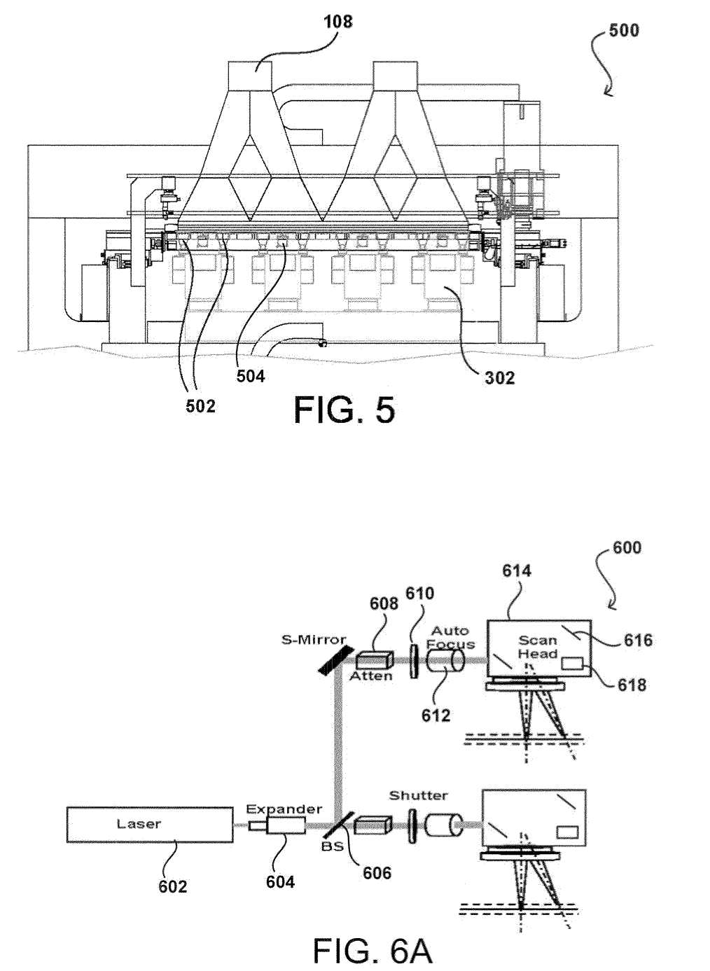

FIG. 5 is a focused view 500 showing that each laser device actually produces two effective beams 502 useful for scribing the workpiece. As can be seen, each portion of the exhaust 108 covers a scan field, or an active area, of the pair of beams in this example, although the exhaust could be further broken down to have a separate portion for the scan field of each individual beam. The figure also shows substrate thickness sensors 504 useful in adjusting heights in the system to maintain proper separation from the substrate due to variations between substrates and/or in a single substrate. Each laser can be adjustable in height (e.g., along the z-axis) using a z-stage, motor, and controller, for example. In some embodiments, the system is able to handle 3-5 mm differences in substrate thickness, although many other such adjustments are possible. The z-motors also can be used to adjust the focus of each laser on the substrate by adjusting the vertical position of the laser itself.

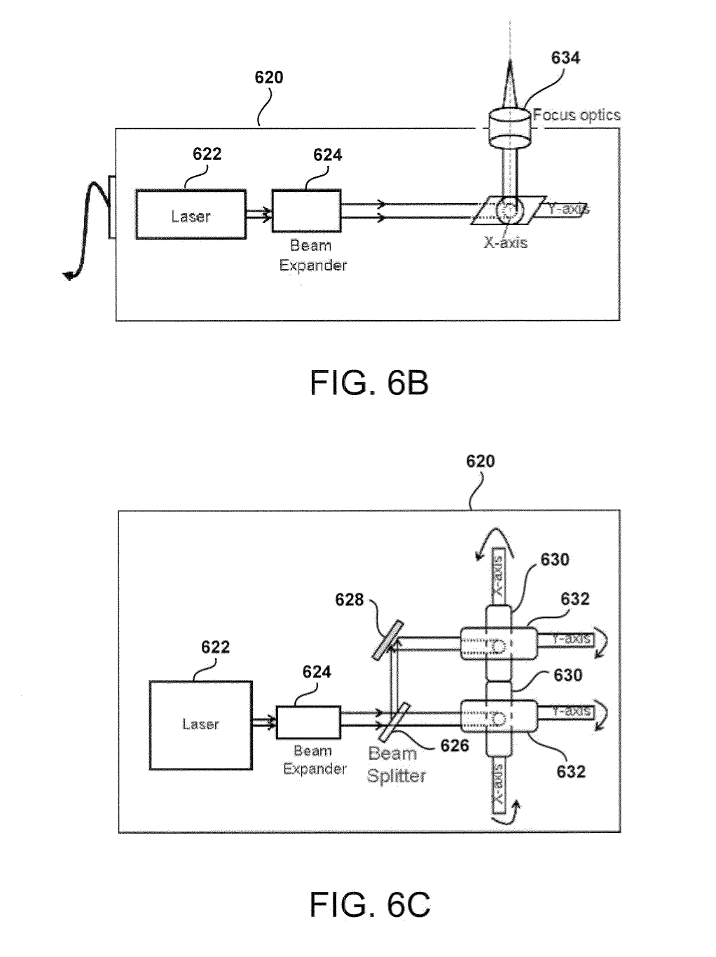

In order to provide the pair of beams, each laser assembly can include at least one beam-splitting device. FIG. 6A illustrates basic elements of an example laser assembly 600 that can be used in accordance with many embodiments, although it should be understood that additional or other elements can be used as appropriate. In this assembly 600, a single laser device 602 generates a beam that is expanded using a beam collimator 604 then passed to a beam splitter 606, such as a partially transmissive mirror, half-silvered mirror, prism assembly, etc., to form first and second beam portions. In this assembly, each beam portion passes through an attenuating element 608 to attenuate the beam portion, adjusting an intensity or strength of the pulses in that portion, and a shutter 610 to control the shape of each pulse of the beam portion. Each beam portion then also passes through an auto-focusing element 612 to focus the beam portion onto a scan head 614. Each scan head 614 includes at least one element capable of adjusting a position of the beam, such as a galvanometer scanner useful as a directional deflection mechanism. In many embodiments, this is a rotatable mirror able to adjust the position of the beam along a lateral direction, orthogonal to the movement vector of the workpiece, which can allow for adjustment in the position of the beam relative to the intended scribe position. The scan heads then direct each beam concurrently to a respective location on the workpiece. A scan head also can provide for a short distance between the apparatus controlling the position for the laser and the workpiece. Therefore, accuracy and precision is improved. Accordingly, the scribe lines can be formed more precisely (i.e., a scribe 1 line can be closer to a scribe 2 line) such that the efficiency of a completed solar module is improved over that of existing techniques.

In many embodiments, each scan head 614 includes a pair of rotatable mirrors 616, or at least one element capable of adjusting a position of the laser beam in two dimensions (2D). Each scan head includes at least one drive element 618 operable to receive a control signal to adjust a position of the “spot” of the beam within the scan field and relative to the workpiece. In some embodiments, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to laterally scan the beam (e.g., in one or more dimensions) means that any pattern can be formed on the workpiece via scribing without having to rotate the workpiece.

FIGS. 6B and 6C show a side-view illustration and a top-view illustration, respectively, of a compact laser-optics module 620 that can be used in accordance with various embodiments. The compact module 620 includes a laser 622, a beam collimator 624, a beam splitter 626, a mirror 628, one or more scanning mirrors 630, 632, and one or more focusing optical assemblies 634. The laser 622 can comprise a range of existing lasers. For example, the laser 622 can comprise a lightweight, small footprint laser. Existing second harmonic solid state lasers of sufficient power for scribing thin-film solar panel scribe lines can be made as light as 1 kg with a size of approximately 150 mm by 100 mm by 50 mm. A laser power supply and/or chiller can be located exterior to the compact module 620. The laser 622 generates a beam that is collimated using the beam collimator 624. The beam collimator 624 can be used to change the size of the laser beam and can be coupled with the laser 622, for example, attached to the laser adjacent to the output of the laser 622. The beam splitter 626 receives the collimated beam from the collimator 624 and splits the collimated beam into 2 nominally equal beam portions. In many embodiments, a power-attenuation aperture (not shown) can be placed along each beam path to finely adjust laser power and beam size. In many embodiments, an attenuating element (see attenuating element 608 in FIG. 6A) can be placed along each beam path to attenuate the beam portion, adjusting an intensity or strength of the pulses in that portion. In many embodiments, a shutter (see shutter 610 in FIG. 6A) can be placed along each beam path to control the shape of each pulse of the beam portion. In many embodiments, an auto-focusing element (see auto-focusing element 612 in FIG. 6A) can be placed along each beam path to focus the beam portion onto the one or more scanning mirrors. The one or more scanning mirrors 630, 632 can be actuated about one or more axes, for example, one or more galvanic scanning mirrors can be actuated about an x-axis and a y-axis to provide for two-dimensional scanning of the laser output. In many embodiments, the one or more scanning mirrors 630, 632 comprise individual galvanic scanning mirrors as opposed to a scan head (e.g., scan head 614 in FIG. 6A). Each of the scanned beam portions can then be passed through a focus optical assembly 634, which in many embodiments comprises a telecentric lens.

In many embodiments, the compact module 620 provides the functionality of the laser assembly 600 (shown in FIG. 6A) and various advantages. For example, the layout, rigidity, footprint, and/or weight of the compact module 620 may have a positive direct impact on the reliability and serviceability of the compact module 620 and the whole laser-scribing system. In many embodiments, the use of a single beam collimator before the beam is split may provide a simplified optical beam path and enhanced reliability. In many embodiments, the use of two individual scanning mirrors in place of an enclosed commercial scan head may help to reduce the weight and footprint of the compact module 620, which may serve to improve reliability and serviceability. In many embodiments, the use of a light weight all-in-one box laser module may be easier to install/uninstall and may serve to isolate the optical components from dust, which may reduce the chance for contamination of the optical components.

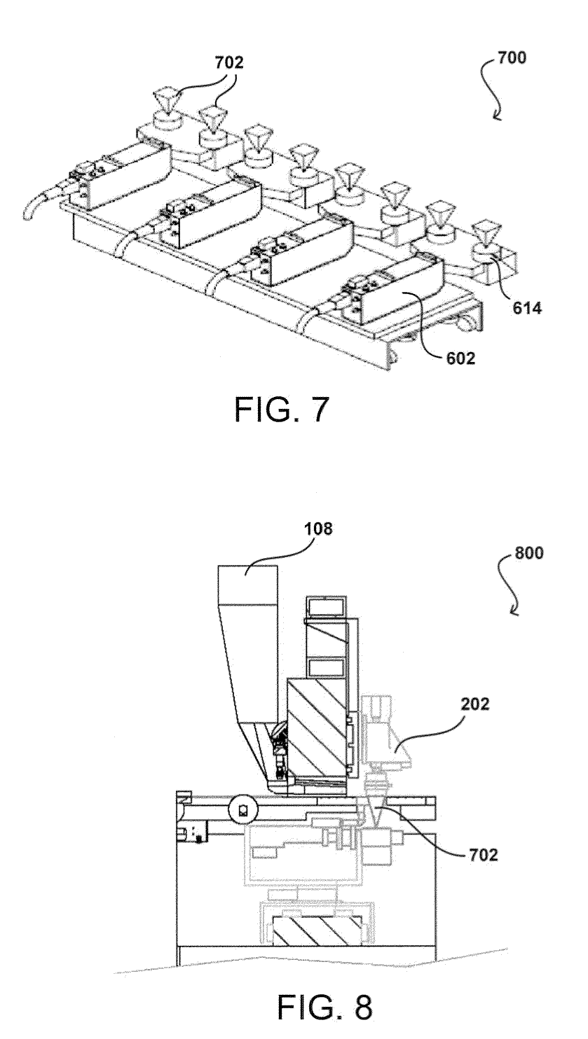

The use of multiple scanned beams can be used to provide increased coverage of the substrate. For example, FIG. 7 illustrates a perspective view 700 of the laser scribing assemblies. The pulsed beam from each laser is split along two paths, each being directed to a 2D scan head 614. As shown, the use of a 2D scan head results in a substantially square scan field for each beam, represented by a pyramid 702 exiting each scan head. By controlling a size and position of the square scan fields relative to the workpiece, the lasers are able to effectively scribe any location on the substrate while making a minimal number of passes over the substrate. If the positions of the scan fields substantially meet or overlap, the entire surface could be scribed in a single pass of the substrate relative to the laser assemblies in many embodiments.

FIG. 8 illustrates a side view 800 of the active region 702 of a laser directed toward the bottom surface of the workpiece. As discussed, the layers are on the opposite side of the workpiece, such that the laser passes through the substrate and scribes the layers on the top side in this arrangement, thus causing the material to ablate off the surface and be extracted by the exhaust 108. As discussed, an imaging device 202 or profiler can image the pattern scribed on the workpiece to ensure proper control of the pulsed beam by the respective scan head. Further, while four lasers are shown with two beam portions each for a total of eight active beams, it should be understood that any appropriate number of lasers and/or beam portions can be used as appropriate, and that a beam from a given laser can be separated into as many beam portions as is practical and effective for the given application. Further, even in a system where four lasers produce eight beam portions, fewer than eight beam portions can be activated based on the size of the workpiece or other such factors. Optical elements in the scan heads also can be adjusted to control an effective area or spot size of the laser pulses on the workpiece, which in many embodiments vary from about 25 microns to about 100 microns in diameter.

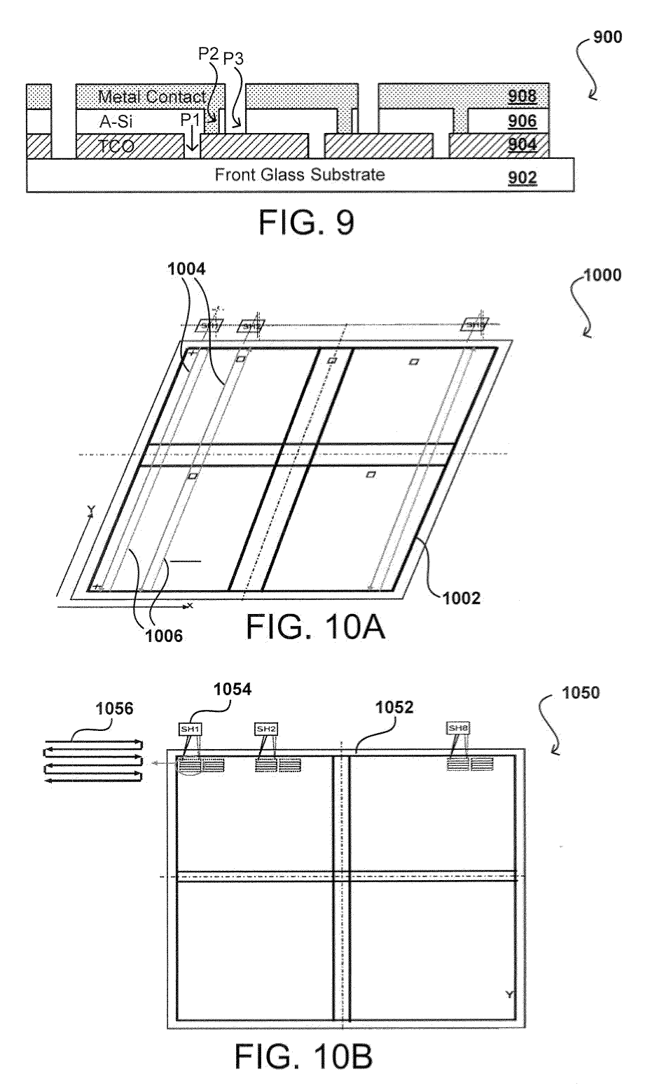

In many embodiments, such a device can be used to scribe lines in multi-junction solar-cell panels. FIG. 9 illustrates an example solar-panel assembly 900 of a set of thin-film solar cells that can be formed in accordance with many embodiments. In this example, a glass substrate 902 has deposited thereon a transparent-conductive-oxide (TCO) layer 904, which then has scribed therein a pattern of first scribe lines (e.g., scribe 1 lines or P1 lines). An amorphous-silicon layer 906 is then deposited, and a pattern of second scribe lines (e.g., scribe 2 lines or P2 lines) formed therein. A metal back layer 908 then is deposited, and a pattern of third scribe lines (e.g., scribe 3 lines or P3 lines) formed therein. The area between adjacent P1 and P3 (including P2 therebetween) lines is a non-active area, or dead zone, which is desired to be minimized in order to improve efficiency of the overall solar-panel array. Accordingly, it is desirable to control the formation of the scribe lines and/or the spacing therebetween, as precisely as possible.

FIG. 10A illustrates an approach 1000 for scanning a series of longitudinal scribe lines on a workpiece 1002. As shown, the substrate is moved continually in a first direction, wherein the scan field for each beam portion forms a scribe line 1004 moving “down” the substrate. In this example, the workpiece is then moved relative to the laser assemblies, such that when the substrate is moved in the opposite direction, each scan field forms a scribe line going “up” the workpiece (directions used for describing the figure only), with the spacing between the “down” and “up” scribes being controlled by the lateral movement of the workpiece relative to the laser assemblies. In this case, the scan heads may not deflect each beam at all. The laser repetition rate can simply be matched to the stage translation speed, with a necessary region of overlap between scribe positions for edge isolation. At the end of a scribing pass, the stage decelerates, stops, and re-accelerates in the opposite direction. In this case, the laser optics are stepped according to the required pitch so that the scribe lines are laid down at the required positions on the glass substrate. If the scan fields overlap, or at least substantially meet within a pitch between successive scribe lines, then the substrate does not need to be moved laterally relative to the laser assemblies, but the beam position can be adjusted laterally between “up” and “down” movements of the workpiece in the laser scribe device. In many embodiments, the laser can scan across the workpiece making a scribe mark at each position of a scribe line within the scan field, such that multiple scribe longitudinal scribe lines can be formed at the same time with only one complete pass of the workpiece being necessary. Many other scribe strategies can be supported as would be apparent to one of ordinary skill in the art in light of the teachings and suggestions contained herein.

FIG. 10B illustrates an approach 1050 for scanning a series of latitudinal (or lateral) scribe lines on a workpiece 1052. As discussed above, each scan head 1054 is able to scan laterally within the scan field of each beam, such that each scan head can create a portion of a scribe line at each position of the workpiece. As shown, each beam can move in one latitudinal direction at one position of the workpiece, then in another latitudinal directions at another position of the workpiece, forming a series of serpentine patterns 1054 as shown in more detail at 1056. As discussed later herein, all latitudinal scribing directions are the same in some embodiments. If the scan fields sufficiently meet, then a full latitudinal scribe line can be formed at each position of the workpiece. If not, the workpiece may need to make several passes in order to form the latitudinal lines, as shown in FIG. 10B.

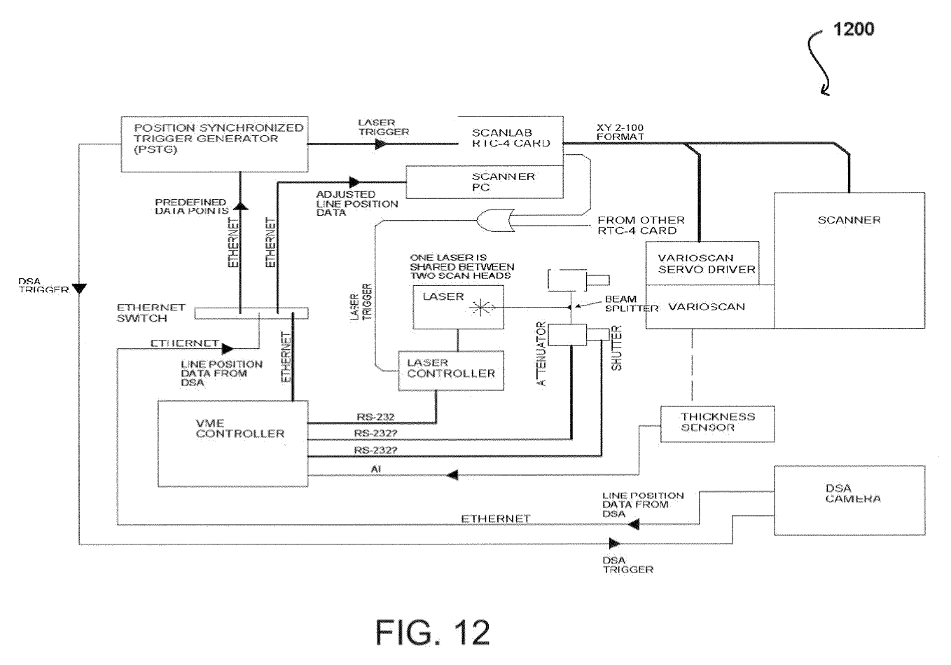

FIG. 11 illustrates a control design 1100 that can be used for a laser scribe device in accordance with many embodiments, although many variations and different elements can be used as would be apparent to one of ordinary skill in the art in light of the teachings and suggestions contained herein. In this design, a workstation 1102 works through a Virtual Machine Environment (VME) controller 1104, such as by using an Ethernet connection, to work with a pulse generator 1106 (or other such device) for driving the workpiece translation stage 1108 and controlling a strobe lamp 1110 and imaging device 1112 for generating images of the scribe position(s). The workstation also works through the VME controller 1104 to drive the position of each scanner 1114, or scan head, to control the spot position of each beam portion on the workpiece., and to control the firing of the laser 1116 via the laser controller 1118. FIG. 12 illustrates a flow of data 1200 through these various components.

In many embodiments, scribe placement accuracy is guaranteed by synchronizing the workpiece translation stage encoder pulses to the laser and spot placement triggers. The system can ensure that the workpiece is in the proper position, and the scanners directing the beam portions accordingly, before the appropriate laser pulses are generated. Synchronization of all these triggers is simplified by using the single VME controller to drive all these triggers from a common source. Various alignment procedures can be followed for ensuring alignment of the scribes in the resultant workpiece after scribing. Once aligned, the system can scribe any appropriate patterns on a workpiece, including fiducial marks and bar codes in addition to cell delineation lines and trim lines.

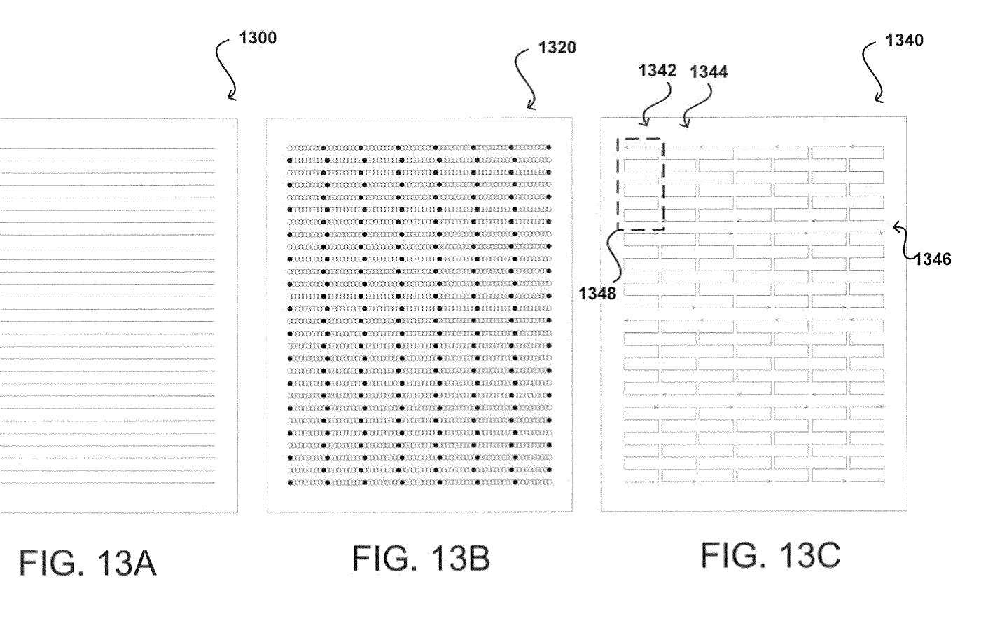

In some embodiments, it is desirable to form portions of multiple lines with a single scanner at a particular longitudinal position of the workpiece. FIG. 13A displays an example of a pattern of parallel scribe lines 1300 to be formed in a layer of the workpiece. Since the workpiece moves longitudinally through the scribing device in this embodiment, the scanner devices must direct each beam laterally so as to form portions or segments of the latitudinal lines within the active area of each scanner device. In the example 1320 of FIG. 13B, it can be seen that each scribe line is actually formed of a series of overlapping scribe “dots,” each being formed by a pulse of the laser directed to a particular position on the workpiece. In order to form continuous lines, these dots must sufficiently overlap, such as by about 25% by area. Portions from each active area must then also overlap in order to prevent gaps. These overlap regions between dots formed by separate active areas can be seen by looking to the black dots in FIG. 13B, which represent the beginning of each scan portion in a serpentine approach. In this example, where there are seven regions shown, if there are seven scanner devices then the pattern can be formed via a single pass of the substrate through the device, as each scanning device can form one of the seven overlapping portions and continuous lines can be thus be formed on a single pass. If, however, there are fewer scanning devices than are necessary to form the number of regions, or the active areas are such that each scanning device is unable to scribe one of these segments, then the substrate may have to make multiple passes through the device. FIG. 13C shows an example 1340 where each scanning device scans according to a pattern at each of a plurality of longitudinal positions of the workpiece. The patterns are used for a latitudinal region along a longitudinal direction, in order to form a segment of each of the scribe lines in a first longitudinal pass of the workpiece through the device. A second segment of each line then is formed using the pattern in an opposite longitudinal pass of the workpiece. The pattern here is a serpentine pattern that allows multiple line segments to be formed by a scanning device for a given longitudinal position of the workpiece. In one example, the patterns of column 1342 can be made by a first scanner as the workpiece travels through the device in a first longitudinal direction. That same scanner can utilize the pattern of column 1344 when the workpiece is then directed back in the opposite longitudinal direction, and so on, in order to form the sequential lines on the workpiece. It should be understood that scribing could occur using the same pattern in the same direction, such as when scribing does not occur when the workpiece moves in the opposite longitudinal direction. Also, certain embodiments may move the workpiece laterally between passes, while other embodiments may move the scanners, lasers, optical elements, or other components laterally relative to the workpiece. Such a pattern could be used with one or multiple scanning devices.

In many embodiments, a latitudinal movement occurs for a set of line segments, then the workpiece is moved longitudinally, then another latitudinal movement occurs to form another set, and so on. In many embodiments, the workpiece moves longitudinally at a constant rate, such that the latitudinal movement back and forth requires different scribing patterns between latitudinal passes. These embodiments can result in an alternating of patterns as illustrated by shift position 1346 in FIG. 13C. In this example, all pattern portions above 1346 are scribed during movement in a first latitudinal direction, while the portions directly below 1346 are scribed for the opposite latitudinal direction. The pattern corresponding to area 1348 is scribed by an active area of a single scanner during a substantially continuous latitudinal movement and, depending upon the embodiment, a fixed or substantially continuous longitudinal movement.

Because the scribing for areas such as 1348 occurs during latitudinal motion, however, a pattern must be used that accounts for this motion. If everything was stationary when etching portion 1348 as shown in FIG. 13C, then the substantially rectangular pattern as shown could be used at each position. In certain embodiments things are moving relatively continually, however, as this minimizes errors due to stopping and starting, etc. When the system is moving laterally, a simple rectangular pattern approach would not result in substantially evenly-spaced and overlapping line portions.

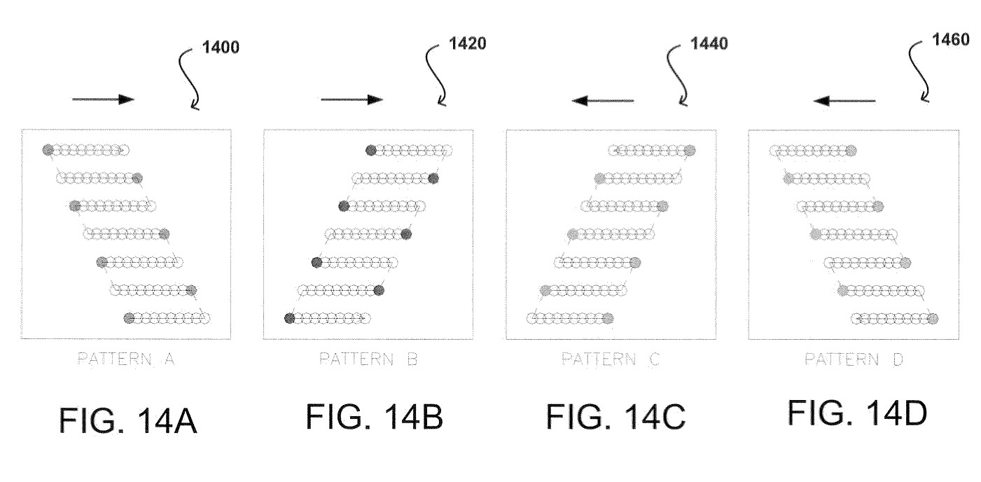

Accordingly, scan patterns can be used that take into account this latitudinal movement. For example, consider the example serpentine pattern 1400 of FIG. 14A. If the position of the scanning device relative to the workpiece is in the direction of the arrow above the pattern, there is no longitudinal movement during latitudinal scanning, and scribing using the pattern starts at the bottom in the figure following the serpentine pattern, then the scanning device will have to account for the fact that the latitudinal position has changed since the scribing of the first line segment when starting the second line segment of the pattern. Each pattern accounts for this by laterally offsetting the second line segment (and each subsequent line segment). The offset can be determined by, and calibrated to, the velocity of the latitudinal movement. As discussed above, the latitudinal motion can be due to movement of the scanning device, laser device, workpiece, or a combination thereof. In FIG. 14B, the scanner is moving from top to bottom instead of bottom to top as in the first pattern. As such, a second pattern 1420 is used that is substantially inverted top to bottom relative to the first pattern 1400.

When the latitudinal motion is in the opposite direction, as shown by the arrows above the patterns of FIGS. 14C and 14D, the patterns 1440, 1460 are mirrored right to left relative to the patterns of FIGS. 14A and 14B, as the patterns have to account for latitudinal motion in the opposite direction and thus have an offset between line segments in the opposite direction.

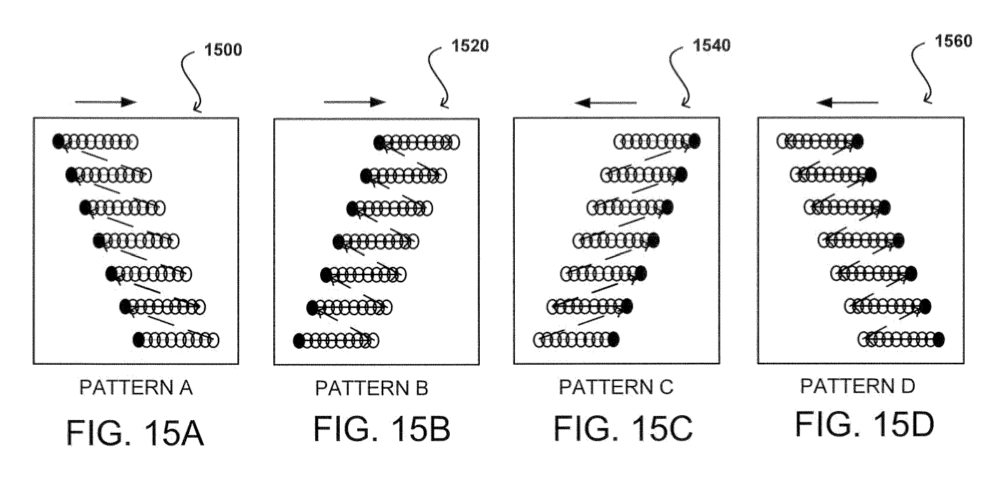

While serpentine patterns can minimize the amount of scan travel, and in some embodiments might slightly improve throughput, other embodiments utilize patterns that always scan in the same latitudinal direction. For example, the patterns 1500, 1520 of FIGS. 15A and 15B are similar to the patterns of FIGS. 14A and 14B, in that they compensate for lateral movement of the scanners, for example, in a first direction. In this example, however, the scan patterns always move left to right for this lateral movement, creating what is referred to herein as a raster pattern. While more motion of the scanner might be required between scribe lines, the scribing is always in the same direction for a given direction of lateral motion, such that differences in scan patterns do not have to be calculated. For example, in a serpentine pattern a first line would be in a first direction that is the same as the motion of the scanner, so the spacing of the pattern would be a first distance. For the next line, if the formation of the line goes in the opposite direction against the direction of movement of the scanner, then a different pattern spacing needs to be calculated that takes into account the different direction (and change in relative velocity) of the substrate relative to the scanner. In order to avoid such calculations and calibrations, a raster pattern can be used that always forms scribe lines with (or against) the direction of motion of the scanners. Accordingly, the patterns 1540, 1560 of FIGS. 15C and 15D correspond to the opposite direction of lateral motion using the raster approach.

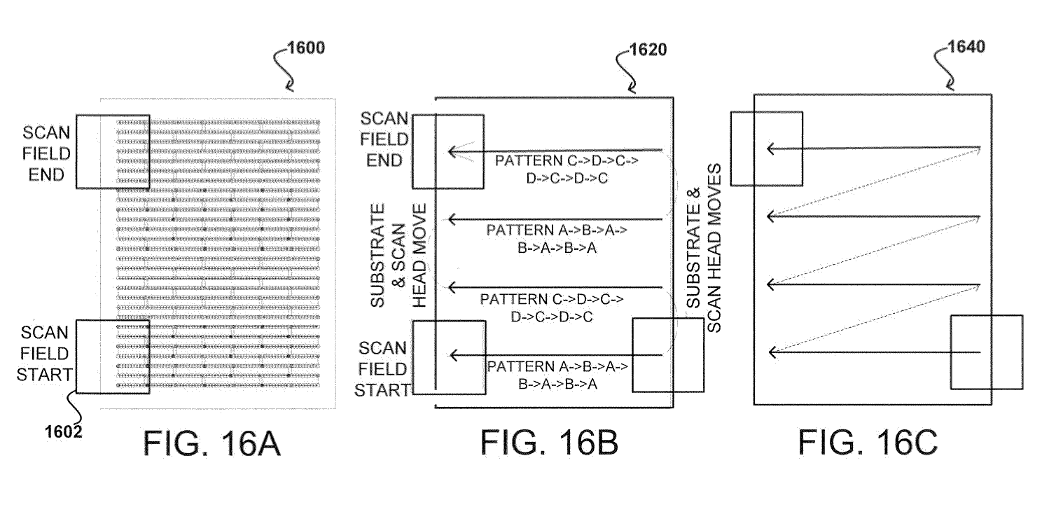

Further, since the active area or scan field for each scanning device is moving during scanning, the pattern that is scribed will necessarily be less than the overall size of the scan field, and will be determined in part by the velocity of the motion. For example, FIG. 16A illustrates a start scan field 1602 over a pattern 1600 to be scribed which shows that the actual portion scribed for the first pattern is about ½ the size of the overall scan field. As the scan field is moved to the right relative to the workpiece, the last line segment that is scribed will begin near the trailing edge of the scan field. When the first pattern (i.e., pattern A) is scribed, then the position of the scan field 1602 will be in position to start with the next pattern (e.g., pattern B). In order to ensure continuous lines, the end of the line segments of each pattern should overlap with the line segments of any adjacent line segments. In one embodiment, the overlap between scribe marks or scribe dots typically is on the order of about 25%. At the ends of the lines, however, the overlap may be greater, such as on the order of about 50%, in order to account for positioning errors between spots and to ensure stitching of the various line segments to form a continuous line.

FIG. 16B gives an overview 1620 of the general process taking advantage of these various pieces using a serpentine approach. As can be seen, the scan field starts at one end of the serpentine pattern, and moves laterally to the right using alternating patterns (e.g., A, B, A, B, etc.) until reaching the end of the lines for that scanning device at that scribing position. At the end of the lines, the substrate is moved longitudinally to advance the scanning device to the next scribing position, and the latitudinal movement occurs in the opposite direction. In this direction, the opposing patterns are used (e.g., C, D, C, D, etc.) until reaching the end of the scan lines in this direction at this scribe position. As can be seen, each scan position results in a number (here 7) of line segments being scribed, and a number (here 7) of patterns stitched together to form longer line segments. Any appropriate number can be used as would be apparent to one of ordinary skill in the art in light of the teachings and suggestions contained herein. The back and forth patterning will continue until reaching the end of the scribe area. FIG. 16C illustrates an overview 1640 using a raster approach.

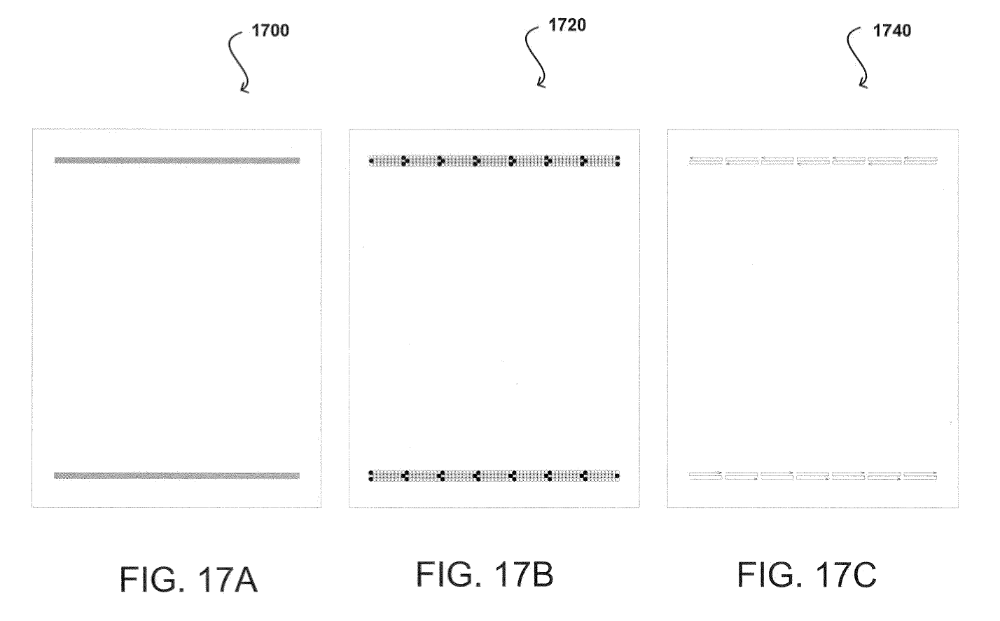

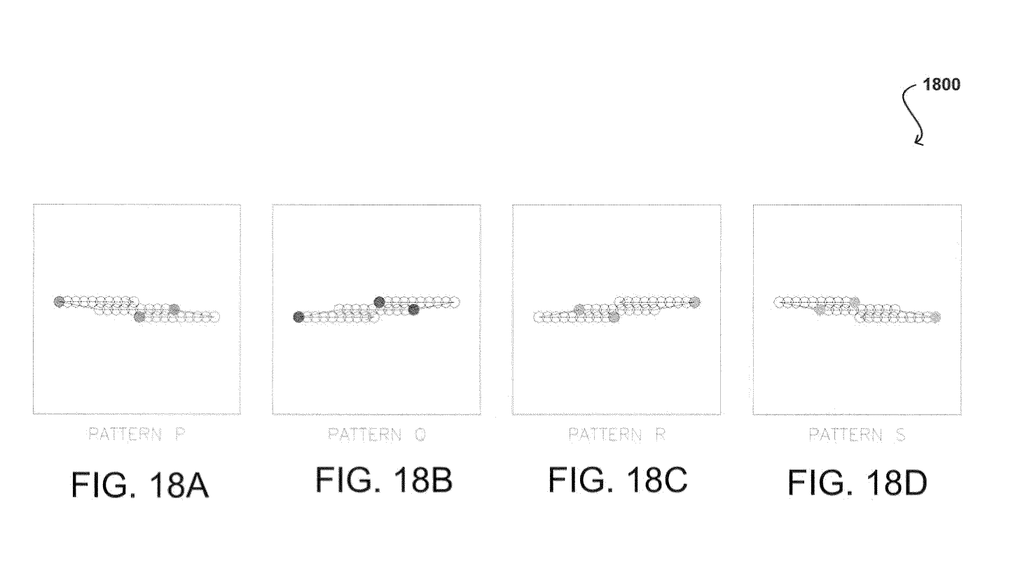

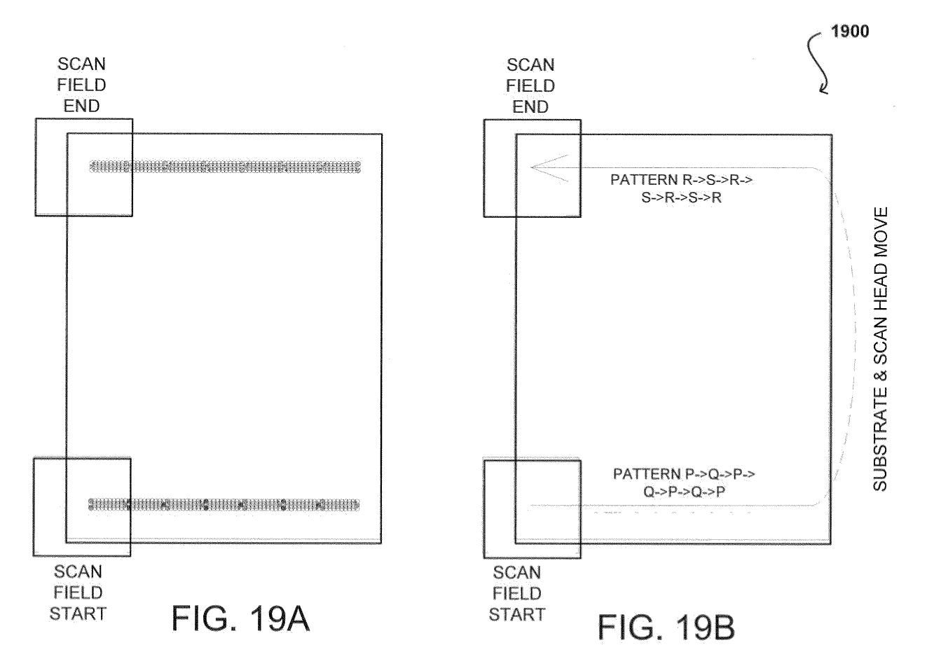

While the description above relates to parallel lines with substantially constant separation, such approaches also can be used to form trim lines or other thick lines that are combinations of various individual scribe lines. For example, FIG. 17A shows a desired scribe result 1700 including a pair of lateral trim lines, each of which is wider than a single scribe line. In order to form the trim lines, a number of overlapping scribe line segments can be used similar to the patterns described above, as shown in the example 1720 of FIG. 17B, but here the individual segments do not have separation and instead overlap to create a single trim line. As shown in the example 1740 of FIG. 17C, serpentine patterns can again be used to form these trim lines. FIGS. 18A-18D illustrate a set of patterns 1800 that can be used to form these thicker lines, using serpentine patterns (e.g., P, Q, R, S) similar to the patterns described above (e.g., A, B, C, D), but with overlapping line segments. Similar raster approaches could be used as should be apparent from the description above. The latitudinal offsets here again account for the latitudinal movement. FIGS. 19A and 19B show an example 1900 of how these patterns can be utilized to form a pair of scribe lines in a fashion that is similar to what is described above.

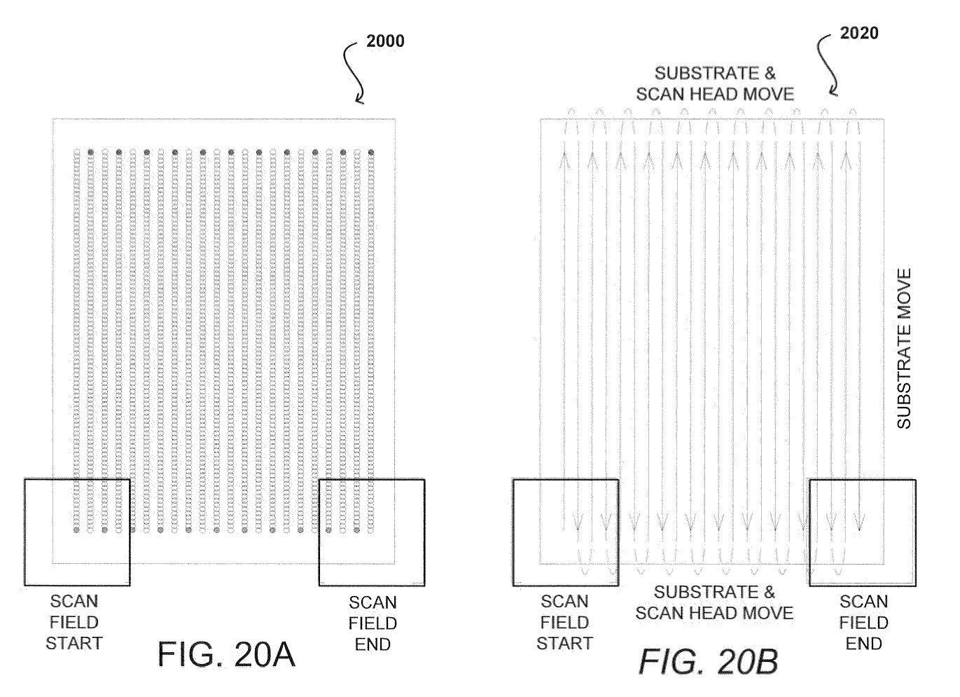

Because solar panels and other workpieces typically utilize both latitudinal and longitudinal lines, FIGS. 20A and 20B illustrate examples 2000, 2020 of an approach that can be used to form longitudinal scribes. As shown in this example, the substrate is moved back and forth longitudinally and only one scribe line is formed at any given time for any scan field. The position of the scan field is simply adjusted at the end of each line, and there is no latitudinal motion during scribing. In another example, there is constant latitudinal motion along with the longitudinal movement, with a single line being scribed for each scanning device, but a diagonal pattern is used for each scanning device to compensate for the latitudinal movement. In another embodiment, each scanning device can scribe dots for each of multiple lines similar to patterns described above, and can continue to go back and forth laterally until reaching the end of the longitudinal lines. There can be different advantages and disadvantages regarding positioning errors with these various approaches.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for scribing a workpiece, the system comprising:
a translation stage operable to support the workpiece and translate the supported workpiece in a longitudinal direction;
a laser operable to generate output able to remove material from at least a portion of the workpiece;
a scanning device operable to control a position of the output from the laser; and
a controller coupled with the translation stage, the laser, and the scanning device,
wherein the controller is operable to coordinate a position of the translation stage with the generation of an output from the laser and with a scanned position of the output from the laser, and wherein patterns in two dimensions are able to be scribed on the workpiece without rotating the workpiece.

2. The system of claim 1, further comprising a translation mechanism operable to reposition the scanning device laterally relative to the longitudinal direction.

3. The system of claim 1, wherein the scanning device is operable to control a position of the output from the laser in two dimensions.

4. The system of claim 1, further comprising additional lasers operable to generate output able to concurrently remove material from additional portions of the workpiece.

5. The system of claim 1, further comprising:
a beam-splitting element; and
at least one additional scanning device,
wherein each scanning device is operable to control a position of a portion of the output from the laser after passing through the beam-splitting element.

6. The system of claim 5, further comprising a distinct laser optics module comprising:
the laser;
the beam-splitting element;
the scanning device; and
the at least one additional scanning device.

7. The system of claim 6, wherein the laser optics module further comprises a beam collimator.

8. The system of claim 7, wherein the laser optics module further comprises at least one of an attenuating element, a shutter, an auto-focusing element, or a focus optical assembly.

9. The system of claim 1, wherein the workpiece includes a substrate and at least one layer used for forming a solar cell, and wherein the laser is able to remove material from the at least one layer.

10. The system of claim 1, further comprising a substrate thickness sensor for determining a thickness of the workpiece, and wherein a focus point of the laser is able to be adjusted in response to the determined thickness.

11. The system of claim 1, further comprising a pulse generator connected with the controller, wherein the pulse generator is connected with the translation stage and is operable to generate a laser trigger pulse.

12. The system of claim 1, further comprising:
a strobe lamp; and
an imaging device,
wherein the strobe lamp and the imaging device are operable to generate an image of one or more scribe positions.

13. A system for scribing a workpiece, the system comprising:
a translation stage operable to support the workpiece and translate the supported workpiece in a longitudinal direction;
a laser operable to generate output able to remove material from at least a portion of the workpiece; and
a scanning device operable to control a position of the output from the laser,
wherein the scanning device utilizes at least one scribe pattern enabling the scanning device to scribe a desired pattern into the workpiece during relative lateral motion between the scanning device and the workpiece.

14. The system of claim 13, wherein the at least one scribe pattern includes at least a first lateral pattern for use when the scanning device moves in a first lateral direction relative to the workpiece and at least a second lateral pattern for use when the scanning device moves in a second lateral direction relative to the workpiece that is opposite the first lateral direction.

15. The system of claim 14, wherein the first lateral pattern includes directing a series of sequential laser pulses so as to sequentially form a laser scribe line in the first lateral direction.

16. The system of claim 14, wherein the first lateral pattern includes directing a series of sequential laser pulses so as to sequentially form a laser scribe line in the second lateral direction.

17. The system of claim 14, wherein the second lateral pattern includes directing a series of sequential laser pulses so as to sequentially form a laser scribe line in the second lateral direction.

18. The system of claim 13, wherein the at least one scribe pattern includes directing a series of sequential laser pulses so as to form a laser scribe line having a plurality of overlapping line segments.

19. The system of claim 13, wherein the scanning device further utilizes at least a first longitudinal pattern for use when the scanning device moves in a first longitudinal direction relative to the workpiece and at least a second longitudinal pattern for use when the scanning device moves in a second longitudinal direction relative to the workpiece that is opposite the first longitudinal direction.

20. The system of claim 13, wherein the workpiece includes a substrate and at least one layer used for forming a solar cell, and wherein the laser is able to remove material from the at least one layer.

21. A method of scribing a workpiece having a longitudinal direction and a lateral direction, the method comprising:
forming a first scribe line having a direction with a lateral component by using a scanning device to direct a first series of sequential laser pulses at the workpiece; and
forming a second scribe line having a direction with a lateral component by using the scanning device to direct a second series of sequential laser pulses at the workpiece, wherein the second scribe line is offset from the first scribe line, and wherein the offset includes a longitudinal component.

22. The method of claim 21, wherein the first scribe line is sequentially formed in a first direction and the second scribe line is sequentially formed in a second direction, the second direction being opposite of the first direction.

23. The method of claim 22, wherein a relative lateral movement occurs between the workpiece and the scanning device during the formation of the first scribe line and during the formation of the second scribe line, and wherein the scanning device compensates for the relative lateral movement.

24. The method of claim 21, wherein the first scribe line and the second scribe line are sequentially formed in the same direction.

25. The method of claim 24, wherein a relative lateral movement occurs between the workpiece and the scanning device during the formation of the first scribe line and the second scribe line, wherein the scanning device compensates for the relative lateral movement.

26. The method of claim 21, further comprising:
forming a third scribe line having a direction with a lateral component by using a scanning device to direct a third series of sequential laser pulses at the workpiece; and
forming a fourth scribe line having a direction with a lateral component by using the scanning device to direct a fourth series of sequential laser pulses at the workpiece,
wherein the third scribe line is connected to the first scribe line, wherein the fourth scribe line is connected to the second scribe line, and wherein the third scribe line and the fourth scribe line are formed subsequent to the formation of the first scribe line and the second scribe line.
